(19) United States
(12) Patent Application Publication
(10) Pub. No.: US 2020/0364393 A1
(43) Pub. Date: Nov. 19, 2020

(54) NON-TRANSITORY COMPUTER-READABLE RECORDING MEDIUM STORING BYPASS CAPACITOR ARRANGEMENT SELECTION PROGRAM, INFORMATION PROCESSING APPARATUS, AND BYPASS CAPACITOR ARRANGEMENT SELECTION METHOD

(71) Applicant: FUJITSU LIMITED, Kawasaki-shi (JP)

(72) Inventors: Tomoyuki NAKAO, Yokohama (JP); Yoshiaki Hiratsuka, Ota (JP); Kenji NAGASE, Yokohama (JP)

(73) Assignee: FUJITSU LIMITED, Kawasaki-shi (JP)

(21) Appl. No.: 16/872,422

(22) Filed: May 12, 2020

(30) Foreign Application Priority Data
May 15, 2019 (JP) 2019-092193

(51) Int. Cl. G06F 30/392; G06F 30/398

(52) U.S. Cl. CPC G06F 30/392; G06F 2119/10; G06F 30/398

(57) ABSTRACT

A non-transitory computer-readable recording medium storing a bypass capacitor arrangement selection program for causing a computer to execute a process, the process includes: setting a first power supply pin of one or more power supply pins located closest to a first signal pin of one or more signal pins, as a power supply pin to which a capacitor for noise countermeasure is coupled, in a circuit component including the one or more signal pins and the one or more power supply pins; and displaying the first power supply pin and a first mark indicating the capacitor for the noise countermeasure in a circuit diagram including display of the circuit component.

### CROSS-REFERENCE TO RELATED APPLICATION

This application is based upon and claims the benefit of priority of the prior Japanese Patent Application No. 2019-92193, filed on May 15, 2019, the entire contents of which are incorporated herein by reference.

### FIELD

The embodiments discussed herein are related to a non-transitory computer-readable recording medium storing a bypass capacitor arrangement selection program, an information processing apparatus, and a bypass capacitor arrangement selection method.

### BACKGROUND

In a circuit display method in a circuit design computer-aided design (CAD) system, a capacitor for noise countermeasure coupled to a power supply pin may be displayed on a page different from each power supply pin. The capacitor for noise countermeasure may be referred to as an electromagnetic interference (EMI) bypass capacitor. The bypass capacitor is also referred to as a bypass condenser (pass con).

Japanese Laid-open Patent Publication No. 2017-76323 and Japanese Laid-open Patent Publication No. 2000-35976 are examples of related art.

### SUMMARY

According to an aspect of the embodiments, a non-transitory computer-readable recording medium storing a bypass capacitor arrangement selection program for causing a computer to execute a process, the process includes: setting a first power supply pin of one or more power supply pins located closest to a first signal pin of one or more signal pins, as a power supply pin to which a capacitor for noise countermeasure is coupled, in a circuit component including the one or more signal pins and the one or more power supply pins; and displaying the first power supply pin and a first mark indicating the capacitor for the noise countermeasure in a circuit diagram including display of the circuit component.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating an example of a hardware configuration of an information processing apparatus according to an example of an embodiment;

FIG. 2 is a block diagram schematically illustrating an example of a functional configuration in the information processing apparatus illustrated in FIG. 1;

FIG. 3 is a display example of an EMI bypass capacitor in the information processing apparatus illustrated in FIG. 1;

FIG. 4 is a table illustrating bypass capacitor information in the display example of the EMI bypass capacitor illustrated in FIG. 3;

FIG. 5 is a display example of the EMI bypass capacitor and a bypass capacitor for power supply in the information processing apparatus illustrated in FIG. 1;

FIG. 6 is a table illustrating bypass capacitor information in the display example of the EMI bypass capacitor and the bypass capacitor for power supply illustrated in FIG. 5;

FIG. 7 is a diagram for describing arrangement processing of the EMI bypass capacitor in the information processing apparatus illustrated in FIG. 1;

FIG. 8 is a table illustrating power supply pin library information of an integrated circuit illustrated in FIG. 7;

FIG. 9 is a table illustrating power supply pin library information of an integrated circuit illustrated in FIG. 7;

FIG. 10 is a table illustrating power supply pin library information of an integrated circuit illustrated in FIG. 7;

FIG. 11 is a diagram illustrating an example of a pin arrangement of a circuit component;

FIG. 12 is a table illustrating power supply pin library information of the circuit component illustrated in FIG. 11;

FIG. 13 is a table illustrating power supply pin arrangement information of the circuit component illustrated in FIG. 11;

FIG. 14 is a flowchart for describing the arrangement processing of the EMI bypass capacitor in the information processing apparatus illustrated in FIG. 1;

FIG. 15 is a table illustrating network frequency information after frequency extraction from a network name in the information processing apparatus illustrated in FIG. 1; and

FIG. 16 is a table illustrating network frequency information after setting a destination frequency of a two-terminal component in the information processing apparatus illustrated in FIG. 1.

### DESCRIPTION OF EMBODIMENTS

The EMI bypass capacitor is displayed side by side in the same manner as capacitors used for applications other than the noise countermeasure and may be displayed on any page when network names to which the capacitors are coupled match each other.

However, in the circuit design CAD system in the related art, although the coupling between the power supply network and the capacitor may be represented, the arrangement relationship between the power supply pin and the capacitor is not represented.

In designing a substrate pattern, it is not possible to determine which pin the capacitor is to be arranged next to, and any capacitor depending on the skill of the pattern designer is arranged, which causes deterioration in quality and variation in pattern design.

Since arrangement information about the capacitors over the pattern of the substrate may not be represented in a circuit diagram, the optimum arrangement analysis of the capacitors may not be performed at the time of the noise countermeasure.

The circuit design CAD system in the related art has a function of giving an instruction about the arrangement of capacitors, and even when circuit design is performed according to a circuit diagram generated by the circuit design CAD system, it is assumed that the skill of a circuit designer reading the circuit diagram is low. In such a case, variations due to the difference in the circuit designers may occur, which results in deterioration in the quality of the circuit design.

When the number of capacitors is large, the circuit diagram becomes complicated, and the number of pages in the circuit diagram is increased, thereby making it difficult to understand the circuit diagram.

In one aspect, the arrangement of a capacitor for noise countermeasure is determined without depending on the skill of the circuit designer.

Hereinafter, an embodiment is described with reference to the drawings. The following embodiment is merely an example and is not intended to exclude the application of various modification examples and techniques not explicitly described in the embodiment. For example, the present embodiment may be variously modified and changed without departing from the gist of the embodiment.

The drawings are not intended to include only constituent elements illustrated in the drawings and may include other functions and the like.

Hereinafter, the same reference signs indicate the same or similar components in the drawings, and duplicate description thereof is omitted.

### [A] Example of Embodiment

### [A-1] Example of System Configuration

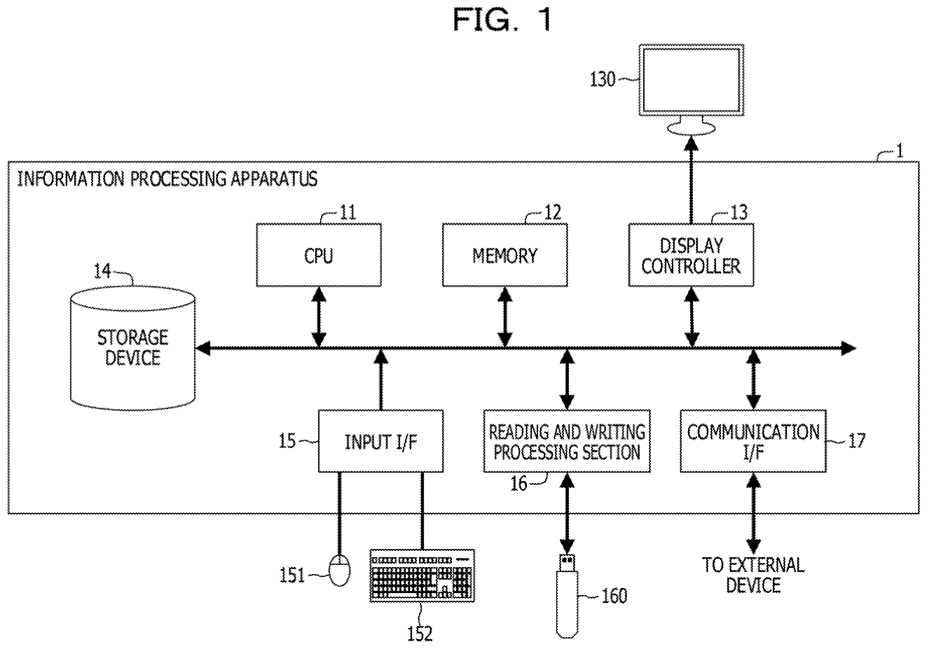

FIG. 1 is a block diagram schematically illustrating an example of a hardware configuration of an information processing apparatus 1.

The information processing apparatus 1 includes a CPU 11, a memory 12, a display controller 13, a storage device 14, an input interface (I/F) 15, a reading and writing processing section 16, and a communication I/F 17.

The memory 12 is an example of a storage section. The memory 12 is, for example, a storage device including a read-only memory (ROM) and a random-access memory (RAM). A program such as a Basic Input and Output System (BIOS) may be written to the ROM of the memory 12. The software program of the memory 12 may be appropriately read into and executed by the CPU 11. The RAM of the memory 12 may be used as a primary recording memory or a working memory.

The display controller 13 is coupled to a display device 130 and controls the display device 130. The display device 130 is a liquid crystal display, an organic light-emitting diode (OLED) display, a cathode ray tube (CRT), an electronic paper display, or the like and displays various information to an operator or the like. The display device 130 may be integrated with an input device and may be a touch panel, for example.

The storage device 14 is, for example, a device that stores data by reading and writing and may be a hard disk drive (HDD), a solid state drive (SSD), or a storage class memory (SCM), for example.

The input I/F 15 may be coupled to input devices such as a mouse 151 and a keyboard 152 and control the input devices such as the mouse 151 and the keyboard 152. The mouse 151 and the keyboard 152 are examples of an input device. The operator performs various input operations via these input devices.

A recording medium 160 may be attached to the reading and writing processing section 16. In a state in which the recording medium 160 is attached to the reading and writing processing section 16, the reading and writing processing section 16 may read information stored in the recording medium 160. In this example, the recording medium 160 has portability. For example, the recording medium 160 is a flexible disk, an optical disc, a magnetic disk, a magneto-optical disc, a semiconductor memory, or the like.

The communication I/F 17 enables communication with an external device.

The CPU 11 is a processing unit that executes various control and computation. The CPU 11 enables various functions by executing the operating system (OS) stored in the memory 12 and a program stored in the memory 12.

The CPU 11 is a device that controls operations to be performed by the entire information processing apparatus 1. The device is not limited to the CPU 11 but may be any one of an MPU, a DSP, an ASIC, a PLD, and an FPGA, for example. The device that controls operations to be performed by the entire information processing apparatus 1 may be a combination of two or more of a CPU, an MPU, a DSP, an ASIC, a PLD, and an FPGA. The MPU is an abbreviation for microprocessor unit, the DSP is an abbreviation for digital signal processor, and the ASIC is an abbreviation for application-specific integrated circuit. The PLD is an abbreviation for programmable logic device, and the FPGA is an abbreviation for field-programmable gate array.

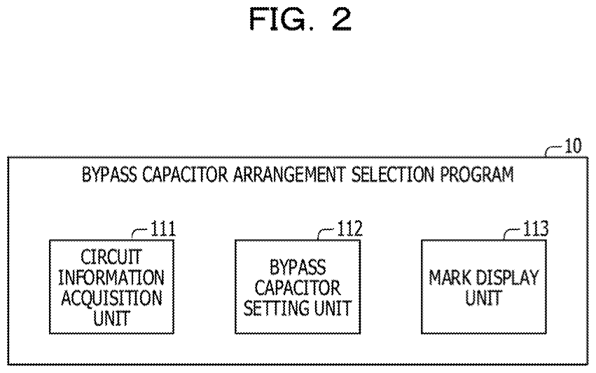

FIG. 2 is a block diagram schematically illustrating an example of a functional configuration in the information processing apparatus 1 illustrated in FIG. 1.

The information processing apparatus 1 executes a bypass capacitor arrangement selection program 10 as illustrated in FIG. 2 by the CPU 11. The bypass capacitor arrangement selection program 10 has functions as a circuit information acquisition unit 111, a bypass capacitor setting unit 112, and a mark display unit 113.

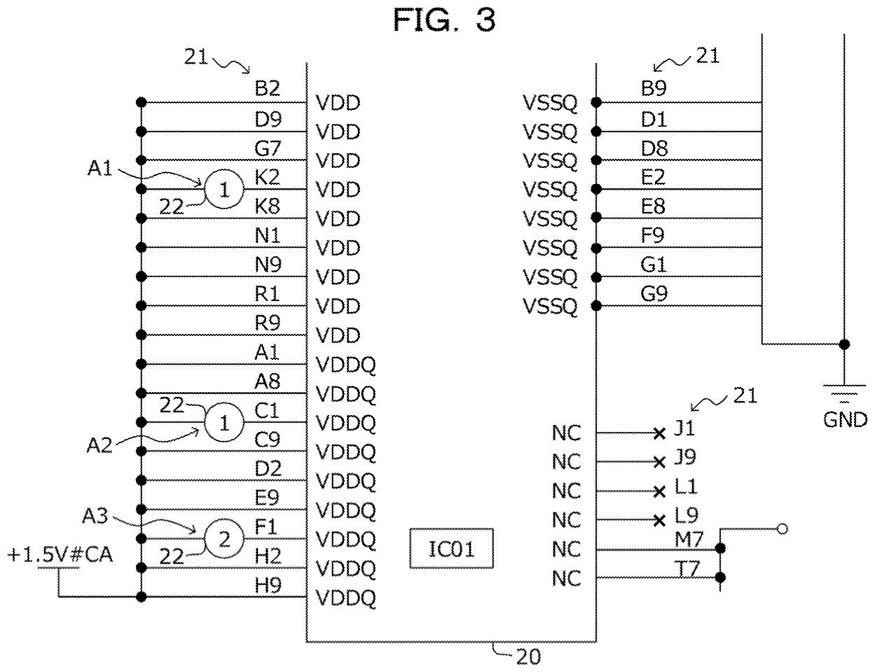

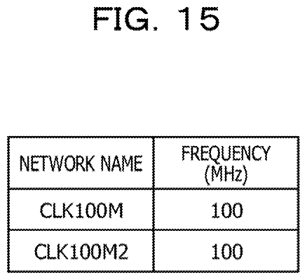

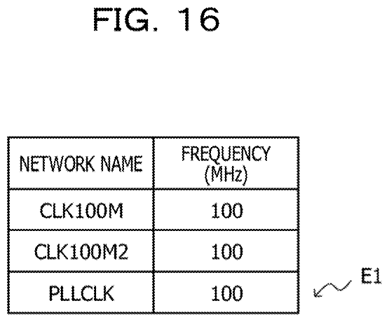

The circuit information acquisition unit 111 creates network frequency information, which will be described later with reference to FIGS. 15 and 16, based on the coupling relationship (in other words, network) between circuit components 20 (to be described later with reference to FIG. 3 and the like) in the circuit.

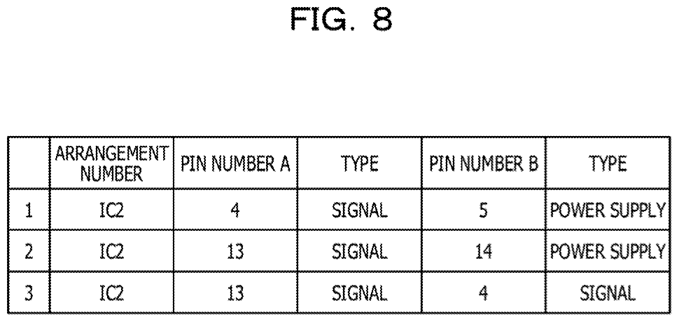

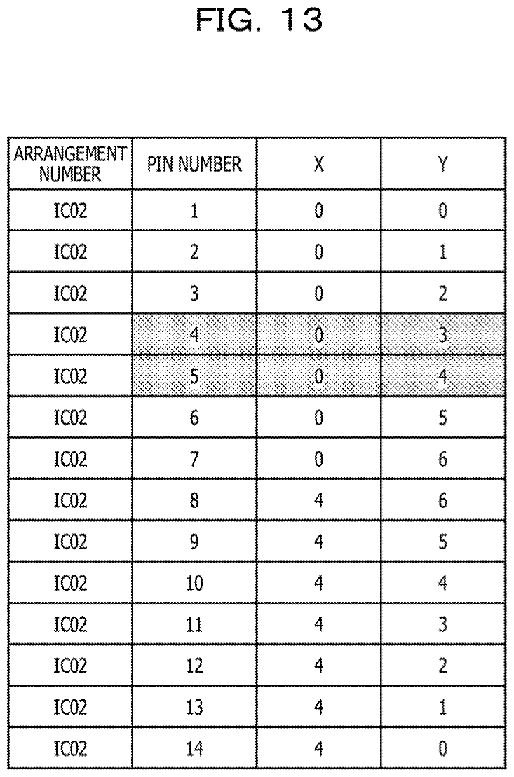

The circuit information acquisition unit 111 creates power supply pin library information (to be described later with reference to FIGS. 8 to 10 and the like) indicating the correspondence relationship between a signal pin and a power supply pin based on power supply pin arrangement information (to be described later with reference to FIG. 13 and the like) indicating arrangement positions of the power supply pins of the circuit component 20 and the network frequency information.

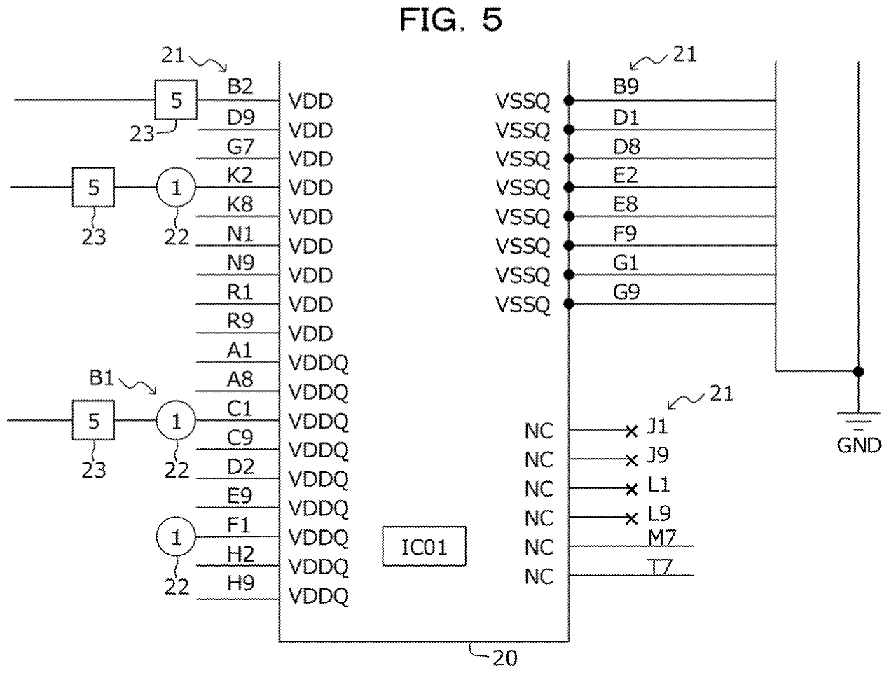

Based on the power supply pin library information, the bypass capacitor setting unit 112 creates bypass capacitor information (to be described later with reference to FIGS. 3, 5 and the like) indicating a power supply pin for which EMI countermeasures are desired.

In other words, the bypass capacitor setting unit 112 functions as an example of a setting unit that sets a first power supply pin of one or more power supply pins located closest to a first signal pin of one or more signal pins, as a power supply pin to which a capacitor for noise countermeasure is coupled.

The network frequency information, the power supply pin arrangement information, the power supply pin library information, and the bypass capacitor information may be stored in the storage device 14.

The mark display unit 113 displays a round mark 22 (to be described later with reference to FIGS. 3, 5 and the like) indicating an EMI bypass capacitor on all the power supply pins included in the bypass capacitor information.

In other words, the mark display unit 113 functions as an example of a display unit that displays a first power supply pin and the round mark 22 indicating a capacitor for noise countermeasure in the circuit diagram including the display of the circuit component 20.

The mark display unit 113 may display the round mark 22 adjacent to the first power supply pin. The mark display unit 113 may display the round mark 22 over a power supply line of the first power supply pin.

FIG. 3 is a display example of an EMI bypass capacitor in the information processing apparatus 1 illustrated in FIG. 1.

The circuit component 20 illustrated in FIG. 3 includes a plurality of pins 21 (a power supply pin and a signal pin). In FIG. 3, when both the power supply pin and the signal pin are displayed, it is difficult to see, so that the display of the signal pin is suppressed.

In the circuit diagram illustrated in FIG. 3, instead of an instruction of the coupling by the circuit symbol about the arrangement of the EMI bypass capacitor, the round mark 22 representing the EMI bypass capacitor is drawn on the display device 130 (refer to FIG. 1) or the like for the power supply pin that desires the bypass capacitor. Thus, information desired for the bypass capacitor arrangement may be accurately transmitted to the operator of the information processing apparatus 1, the number of pages in the circuit diagram may be reduced, and an easy-to-see circuit diagram may be created.

In the example illustrated in FIG. 3, an EMI bypass capacitor “1” is coupled to power supply pins K2 and C1, as indicated by reference signs A1 and A2. As indicated by a reference sign A3, an EMI bypass capacitor “2” is coupled to the power supply pin F1. When the distances between the power supply pins K2, C1, and F1 are close to each other, one EMI bypass capacitor may be shared.

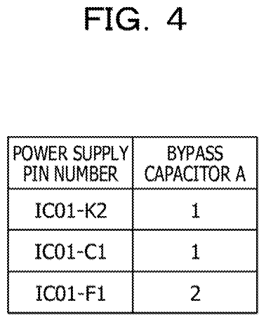

FIG. 4 is a table illustrating bypass capacitor information in the display example of the EMI bypass capacitor illustrated in FIG. 3.

As illustrated in FIG. 4, in the bypass capacitor information of the power supply pin, the power supply pin number and the identification number of the bypass capacitor are associated with each other. In the illustrated example, an EMI bypass capacitor with the identification number “1” is coupled to power supply pins IC01-K2 and IC01-C1. An EMI bypass capacitor with the identification number “2” is coupled to the power supply pins IC01-F1.

The EMI bypass capacitor with the identification number “1” may be a capacitor of 1000 pF and 50 V. The EMI bypass capacitor with the identification number “2” may be a capacitor of 2200 pF and 80 V.

FIG. 5 is a display example of the EMI bypass capacitor and a bypass capacitor for power supply in the information processing apparatus 1 illustrated in FIG. 1. In FIG. 5, when both the power supply pin and the signal pin are displayed, it is difficult to see, so that the display of the signal pin is suppressed. However, both the power supply pin and the signal pin may be displayed.

By increasing the types of marks and colors illustrated in the circuit diagram, it is possible to display a bypass capacitor for power supply other than the EMI bypass capacitor, for example, in the circuit diagram.

In the example illustrated in FIG. 5, the EMI bypass capacitor is indicated by the round mark 22, and the bypass capacitor for power supply is indicated by a square mark 23. The order of the EMI bypass capacitors or the bypass capacitor for power supply from each of the power supply pins may be specified by the order in which the round mark 22 or the square mark 23 from each of the power supply pins is illustrated. As indicated by a reference sign B1, the EMI bypass capacitor indicated by the round mark 22 and the bypass capacitor for power supply indicated by the square mark 23 are coupled to the power supply pin C1 in this order.

The round mark 22 is an example of a first mark, and the square mark 23 is an example of a second mark.

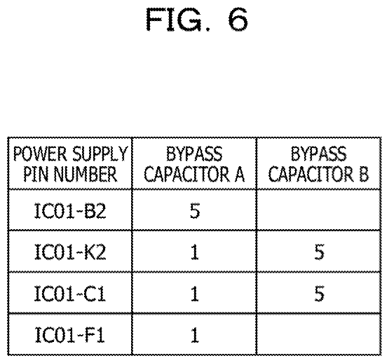

FIG. 6 is a table illustrating bypass capacitor information in the display example of the EMI bypass capacitor and the bypass capacitor for power supply illustrated in FIG. 5.

As illustrated in FIG. 6, in the bypass capacitor information of the power supply pin, the power supply pin number, the identification number of a bypass capacitor A, and the identification number of a bypass capacitor B are associated with each other. The bypass capacitor A is a bypass capacitor coupled to the power supply pin side rather than the bypass capacitor B. When there is only one bypass capacitor coupled to the power supply pin, the identification number of the bypass capacitor A is registered in the bypass capacitor information of the power supply pin, but the identification number of the bypass capacitor B is not registered therein.

In the example indicated by a reference sign B2, to a power supply pins IC01-B2, a bypass capacitor for power supply with the identification number “5” is coupled as the bypass capacitor A. To power supply pins IC01-K2 and IC01-C1, the EMI bypass capacitor with the identification number “1” is coupled as the bypass capacitor A, and the bypass capacitor for power supply with the identification number “5” is coupled as the bypass capacitor B. To a power supply pins IC01-F1, the EMI bypass capacitor with the identification number “1” is coupled as the bypass capacitor A.

The EMI bypass capacitor with the identification number “1” may be a capacitor of 1000 pF and 50 V. The bypass capacitor for power supply with the identification number “5” may be a capacitor of 0.1 μF and 50 V.

In this way, the mark display unit 113 displays the second mark 23 indicating a capacitor for supplying power to the circuit component 20, which is different from the capacitor for noise countermeasure, side by side with the first mark 22.

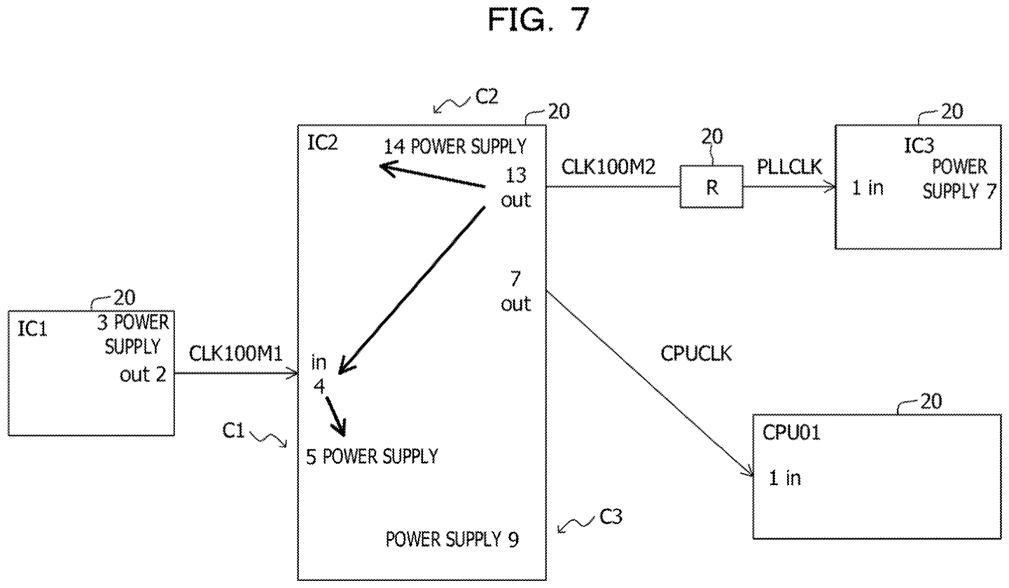

FIG. 7 is a diagram for describing arrangement processing of the EMI bypass capacitor in the information processing apparatus 1 illustrated in FIG. 1. FIG. 8 is a table illustrating power supply pin library information of an integrated circuit IC2 illustrated in FIG. 7.

In FIG. 7, integrated circuits IC1 to IC3, an arithmetic processing unit CPU01, and a resistor R are illustrated as the circuit components 20.

In the power supply pin library information illustrated in FIG. 8, a power supply pin which desires the EMI bypass capacitor is registered based on the frequency (for example, the network name “CLK100M” in FIG. 7 means a frequency of 100 MHz) written in the network name and a pin number A.

When the network names of all the pin couplings of the integrated circuit IC2 are checked, and the frequency is extracted from the network name, the pin number is recorded in the pin number A of the power supply pin library information. Next, the power supply pin number associated with the recorded pin number is recorded as a pin number B. Then, the recording of the pin number A and the pin number B is repeated for all the pins 21. However, when there is a pin 21 with the pin number “4” having the same frequency as the pin number “13”, the pin number “4” is also recorded as the pin number B.

For the integrated circuit IC2, among the power supply pins “5”, “9”, and “14”, the power supply pins “5” and “14” may generate noise from the signal pins, so that it is determined that the EMI bypass capacitor is desired (refer to reference signs C1 and C2 in FIG. 7). Since the power supply pin “9” is less likely to generate noise from the signal pin, it is determined that the EMI bypass capacitor is not desired (refer to a reference sign C3 in FIG. 7).

Since the clock signal passes from the signal pin “13” to the signal pin “4” in the same dock frequency, the signal pin “13” is recorded as the pin number A and the signal pin “4” is recorded as the signal pin 8 in the power supply pin library information. Meanwhile, although the clock signal is also coupled to the signal pin “7”, since the frequency of the clock signal is unknown, the signal pin “7” is not recorded in the power supply pin library information.

The power supply pin library information illustrated in FIG. 8 indicates that noise from the signal pin “4” of the integrated circuit IC2 leaks to the power supply pin “5”, and that noise from the signal pin “13” of the integrated circuit IC2 leaks to the power supply pin “14”. It is indicated that the signal of the signal pin “13” and the signal of the signal pin “4” of the integrated circuit IC2 have the same frequency.

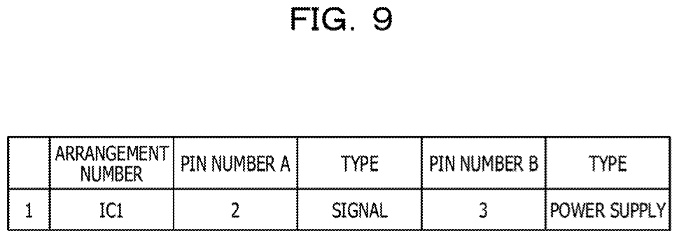

FIG. 9 is a table illustrating power supply pin library information of the integrated circuit IC1 illustrated in FIG. 7.

In the integrated circuit IC1, since the frequency may be discriminated from the coupling network name of the signal pin “2”, the signal pin “2” is recorded in the power supply pin library information as the pin number A. The power supply pin “3” in the vicinity of the signal pin “2” is recorded in the power supply pin library information.

As illustrated in FIG. 9, in the integrated circuit IC1, since the signal whose frequency is known is only the signal pin “2”, the signal pin “2” and the power supply pin “3” are registered in the power supply pin library information.

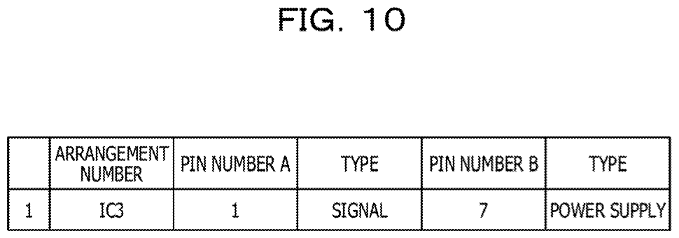

FIG. 10 is a table illustrating power supply pin library information of the integrated circuit IC3 illustrated in FIG. 7.

In the integrated circuit IC3, a network having a frequency is searched. When two terminals of a resistor, a capacitor, and an inductor are coupled to each other, the same frequency is recorded in the network name of the coupling destination. The power supply pin library information is created for the signal pins of the components coupled to the network.

In the example illustrated in FIG. 10, although there is no coupling of the signal whose frequency is known to the integrated circuit IC3, the signal pin “1” is coupled to a signal CLK100M2 whose frequency is known via the two-terminal resistor R of two terminals, so that it is determined that the frequency of a signal PLLCLK is the same as that of the CLK100M2. Therefore, the power supply pin library information is created for the signal pin “1” of the integrated circuit IC3.

In some cases, a numeral indicating a frequency, such as CLK100M or MCLK100P5M is used for the network name coupled to the component. From the network name, a frequency, a component of a coupling destination, and a signal pin are determined.

For example, when the network name is CLK100M, a frequency of 100 MHz is acquired, and when the network name is MCLK100P5M, a frequency of 100.5 MHz is acquired.

In this way, the power supply pin library information is created for the components coupled to the network whose frequency is known. The power supply pin library information may be automatically created by analyzing the circuit.

Since the created power supply pin library information is information unique to the component, it may be reused even in other circuits in which the same component is used. When the power supply pin library information is reused, the power supply pin library information may also be used in circuits where there is no frequency information in the network name.

In many cases, the network name is freely determined by the circuit designer. When the frequency is important like a clock, the network name including the frequency information is used.

Although the power supply pin library information is created for the coupling pin of the network whose frequency is known, the frequency is set even in a network whose frequency is unknown by tracking the coupling between the two-terminal components, so that the power supply pin library information is created.

One or more associated power supply pins are marked as a set for each signal pin. Since the noise of the signal pin leaks from the power supply pin, the EMI bypass capacitor is desired. Therefore, a power supply pin for which noise is easy to leak is selected from a plurality of power supply pins.

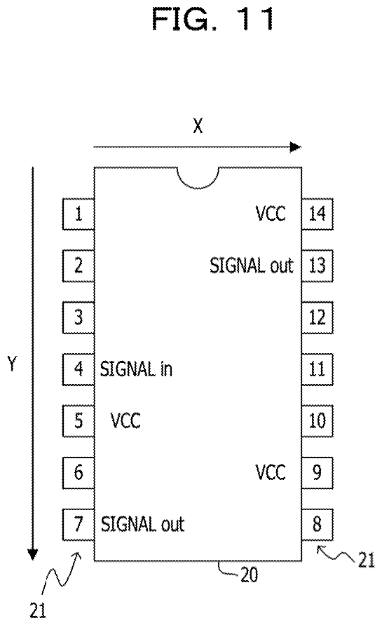

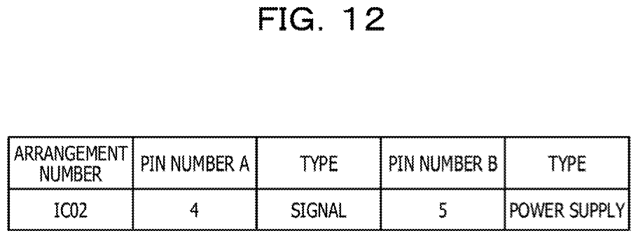

FIG. 11 is a diagram illustrating an example of a pin arrangement of the circuit component 20. FIG. 12 is a table illustrating power supply pin library information of the circuit component 20 illustrated in FIG. 11. FIG. 13 is a table illustrating power supply pin arrangement information of the circuit component 20 illustrated in FIG. 11.

The circuit component 20 illustrated in FIG. 11 includes pins 21 (signal pins and power supply pins) specified by pin numbers “1” to “14”, respectively. In the example illustrated in FIG. 11, the power supply pin library information illustrated in FIG. 12 is created for the power supply pin “5” having a pin number closest to the signal pin “4”.

In this way, the bypass capacitor setting unit 112 sets the power supply pin having an identification number closest to the identification number of the first signal pin in the circuit component 20, as a first power supply pin to which a capacitor for noise countermeasure is coupled.

When the power supply pin arrangement information indicating the distance between the physical pins 21 as illustrated in FIG. 13 is held, power supply pin library information may be created based on the power supply pin arrangement information instead of the pin number. In the example illustrated in FIG. 13, power supply pin library information in which the closest power supply pin “5” which is XY coordinates (0,4) is associated with the power supply pin “4” which is the XY coordinates (0,3) is created (refer to the shaded portion in FIG. 13).

The coordinates may be defined using the actual dimensions of the circuit component 20, or may be a relative number.

In this way, the bypass capacitor setting unit 112 sets the power supply pin having a coordinate position closest to the coordinate position of the first signal pin in the circuit component 20, as the first power supply pin to which the capacitor for noise countermeasure is coupled.

### [A-2] Operation Example

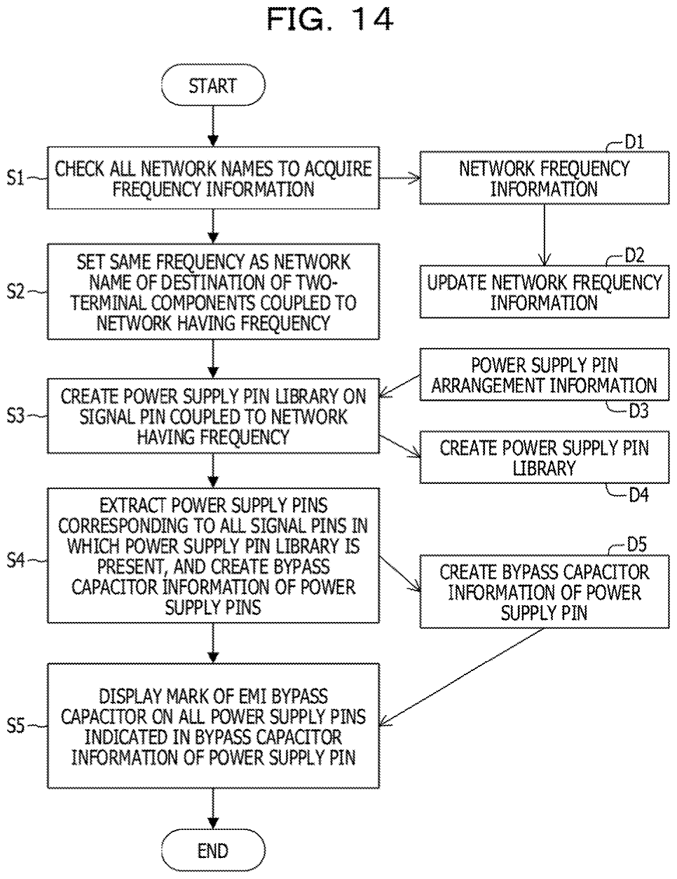

The arrangement processing of the EMI bypass capacitor in the information processing apparatus 1 illustrated in FIG. 1 will be described according to a flowchart (steps S1 to S5) illustrated in FIG. 14 with reference to FIGS. 15 and 16. FIG. 15 is a table illustrating network frequency information after frequency extraction from the network name in the information processing apparatus 1 illustrated in FIG. 1. FIG. 16 is a table illustrating network frequency information after setting a destination frequency of a two-terminal component in the information processing apparatus 1 illustrated in FIG. 1.

The circuit information acquisition unit 111 checks all the network names in the circuit to acquire frequency information (step S1), and updates the network frequency information as illustrated in FIG. 15 (refer to reference signs D1 and D2).

The circuit information acquisition unit 111 sets the same frequency as the network name of the destination of the two-terminal components such as a resistor, a capacitor, and an inductor which are coupled to a network having a frequency (step S2). Thus, the network frequency information is updated as indicated by a reference sign E1 in FIG. 16.

The circuit information acquisition unit 111 creates power supply pin library information on a signal pin coupled to a network having a frequency based on the power supply pin arrangement information (refer to step S3 and reference signs D3 and D4).

The bypass capacitor setting unit 112 extracts power supply pins corresponding to all signal pins in which the power supply pin library information is present, and creates bypass capacitor information of the power supply pins (refer to step S4 and a reference sign D5).

The mark display unit 113 displays the mark of the EMI bypass capacitor on all the power supply pins indicated in the bypass capacitor information of the power supply pin (step S5). Then, the arrangement processing of the EMI bypass capacitor is completed.

### [A-3] Effects

According to the bypass capacitor arrangement selection program 10, the information processing apparatus 1, and the bypass capacitor arrangement selection method described above, the following effects may be achieved, for example.

The bypass capacitor setting unit 112 sets a first power supply pin of one or more power supply pins located closest to a first signal pin of one or more signal pins, as a power supply pin to which a capacitor for noise countermeasure is coupled. The mark display unit 113 displays the first power supply pin and the first mark 22 indicating a capacitor for noise countermeasure in the circuit diagram including the display of the circuit component 20.

Thus, the arrangement of a capacitor for noise countermeasure may be determined without depending on the skill of the circuit designer. Specifically, for example, instead of an instruction of the coupling by the circuit symbol about the arrangement of the EMI bypass capacitor, it is possible to accurately represent the arrangement position of the bypass capacitor in the circuit diagram by drawing the round mark 22 representing the bypass capacitor for the power supply pin that desires the bypass capacitor. The number of pages in the circuit diagram may be reduced, and an easy-to-see circuit diagram may be created.

The bypass capacitor setting unit 112 displays the first mark 22 adjacent to the first power supply pin.

Thus, the circuit designer may immediately understand the coupling relationship between the power supply pin and the EMI bypass capacitor.

The bypass capacitor setting unit 112 displays the first mark 22 over a power supply line of the first power supply pin.

Thus, even if the EMI bypass capacitor is displayed in the circuit diagram, a compact circuit diagram may be created.

The bypass capacitor setting unit 112 sets the power supply pin having an identification number closest to the identification number of the first signal pin in the circuit component 20, as a first power supply pin to which a capacitor for noise countermeasure is coupled.

Thus, the positional relationship between the signal pin and the power supply pin in the circuit component 20 may be easily recognized.

The bypass capacitor setting unit 112 sets the power supply pin having a coordinate position closest to the coordinate position of the first signal pin in the circuit component 20, as the first power supply pin to which the capacitor for noise countermeasure is coupled.

Thus, the positional relationship between the signal pin and the power supply pin in the circuit component 20 may be accurately recognized.

The mark display unit 113 displays the second mark 23 indicating a capacitor for supplying power to the circuit component 20, which is different from the capacitor for noise countermeasure, side by side with the first mark 22.

Thus, it is possible to accurately represent the coupling position to the power supply pin, for example, for a bypass capacitor for power supply other than the EMI bypass capacitor.

### [B] Others

The techniques disclosed herein are not limited to the foregoing embodiment and may be variously modified and changed without departing from the gist of the embodiment. Each of the configurations described in the embodiment and each of the processes described in the embodiment may be selected. Alternatively, two or more of the configurations described in the embodiment may be combined, and two or more of the processes described in the embodiment may be combined.

### [C] Appendix

The following appendices are disclosed in the above embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a bypass capacitor arrangement selection program for causing a computer to execute a process, the process comprising:
setting a first power supply pin of one or more power supply pins located closest to a first signal pin of one or more signal pins, as a power supply pin to which a capacitor for noise countermeasure is coupled, in a circuit component including the one or more signal pins and the one or more power supply pins; and
displaying the first power supply pin and a first mark indicating the capacitor for the noise countermeasure in a circuit diagram including display of the circuit component.

2. The non-transitory computer-readable recording medium according to claim 1, wherein
in the displaying, the first mark is displayed adjacent to the first power supply pin.

3. The non-transitory computer-readable recording medium according to claim 1, wherein
in the displaying, the first mark is displayed over a power supply line of the first power supply pin.

4. The non-transitory computer-readable recording medium according to claim 1, the process further comprising:
setting a power supply pin having an identification number closest to an identification number of the first signal pin in the circuit component, as the first power supply pin.

5. The non-transitory computer-readable recording medium according to claim 1, the process further comprising:
setting a power supply pin having a coordinate position closest to a coordinate position of the first signal pin in the circuit component, as the first power supply pin.

6. The non-transitory computer-readable recording medium according to claim 1, the process further comprising:
displaying a second mark indicating a capacitor for supplying power to the circuit component, which is different from the capacitor for noise countermeasure, side by side with the first mark.

7. An information processing apparatus comprising:
a memory; and
a processor coupled to the memory and configured to:
set a first power supply pin of one or more power supply pins located closest to a first signal pin of one or more signal pins, as a power supply pin to which a capacitor for noise countermeasure is coupled, in a circuit component including the one or more signal pins and the one or more power supply pins; and
display the first power supply pin and a first mark indicating the capacitor for noise countermeasure in a circuit diagram including display of the circuit component.

8. The information processing apparatus according to claim 7, wherein
the processor displays the first mark adjacent to the first power supply pin.

9. The information processing apparatus according to claim 7, wherein
the processor displays the first mark over a power supply line of the first power supply pin.

10. The information processing apparatus according to claim 7, wherein
the processor sets a power supply pin having an identification number closest to an identification number of the first signal pin in the circuit component, as the first power supply pin.

11. The information processing apparatus according to claim 7, wherein
the processor sets a power supply pin having a coordinate position closest to a coordinate position of the first signal pin in the circuit component, as the first power supply pin.

12. The information processing apparatus according to claim 7, wherein
the processor displays a second mark indicating a capacitor for supplying power to the circuit component, which is different from the capacitor for noise countermeasure, side by side with the first mark.

13. A bypass capacitor arrangement selection method comprising:
setting, by a computer, a first power supply pin of one or more power supply pins located closest to a first signal pin of one or more signal pins, as a power supply pin to which a capacitor for noise countermeasure is coupled, in a circuit component including the one or more signal pins and the one or more power supply pins; and
displaying the first power supply pin and a first mark indicating the capacitor for noise countermeasure in a circuit diagram including display of the circuit component.

14. The bypass capacitor arrangement selection method according to claim 13, wherein
in the displaying, the first mark is displayed adjacent to the first power supply pin.

15. The bypass capacitor arrangement selection method according to claim 13, wherein
in the displaying, the first mark is displayed over a power supply line of the first power supply pin.

16. The bypass capacitor arrangement selection method according to claim 13, further comprising:
setting a power supply pin having an identification number closest to an identification number of the first signal pin in the circuit component, as the first power supply pin.

17. The bypass capacitor arrangement selection method according to claim 13, further comprising:
setting a power supply pin having a coordinate position closest to a coordinate position of the first signal pin in the circuit component, as the first power supply pin.

18. The bypass capacitor arrangement selection method according to claim 13, further comprising:
displaying a second mark indicating a capacitor for supplying power to the circuit component, which is different from the capacitor for noise countermeasure, side by side with the first mark.
